(19) United States
(12) Patent Application Publication
(10) Pub. No.: US 2008/0115735 A1
(43) Pub. Date: May 22, 2008

(54) Pet Hair Razor

(76) Inventor: Huo-Pia Wang, Chang-Hua City (TW)

Correspondence Address: MCNEES WALLACE & NURICK LLC, 100 PINE STREET, P.O. BOX 1166, HARRISBURG, PA, 17108-1166, US

(21) Appl. No.: 11/561,951

(22) Filed: Nov. 21, 2006

(51) Int. Cl. B26B 21/12; B26B 21/00; A01K 13/00

(52) U.S. Cl. 119/614; 30/30; 30/50

(57) ABSTRACT

A pet hair razor includes: a handle part having a mounting seat; and a comb part provided with blades that are aligned in a longitudinal direction. Each of the blades has an edged side. The comb part is mountable detachably on the mounting seat between a first position, in which the edged sides of the blades face in a first direction, and a second position, in which the edged sides of the blades face in a second direction opposite to the first direction.

### BACKGROUND OF THE INVENTION

1. Field of the Invention

This invention relates to a pet hair razor, more particularly to a pet hair razor including a detachable comb part.

2. Description of the Related Art

FIG. 1 illustrates a conventional pet hair razor 1 adapted for cutting and combing hair of a pet, such as a dog, a cat, etc.

The pet hair razor 1 includes a handle part 11, a comb part 12 connected to an end of the handle part 11, and blades 13 provided on the comb part 12.

In use, the hair of the pet is combed and cut by the blades 13 at the same time.

The conventional pet hair razor 1 has the following disadvantages:

1) Edged sides 131 of the blades 13 face an operating direction suitable for a right-handed person. As shown in FIG. 2, when the razor 1 is used by a left-handed person, the edge sides 131 of the blades 13 will face a direction that is likely to result in inconvenience during the cutting and combing operation.

2) Since the blades 13 are fixedly mounted on the comb part 12, the whole pet hair razor 1 is discarded when the blades 13 become blunt.

### SUMMARY OF THE INVENTION

Therefore, the object of the present invention is to provide a pet hair razor that can overcome the aforesaid drawbacks associated with the prior art.

Accordingly, a pet hair razor of this invention comprises: a handle part having a mounting seat; and a comb part provided with blades that are aligned in a longitudinal direction. Each of the blades has an edged side. The comb part is mountable detachably on the mounting seat between a first position, in which the edged sides of the blades face in a first direction, and a second position, in which the edged sides of the blades face in a second direction opposite to the first direction.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view showing a conventional pet hair razor used by a right-handed person;

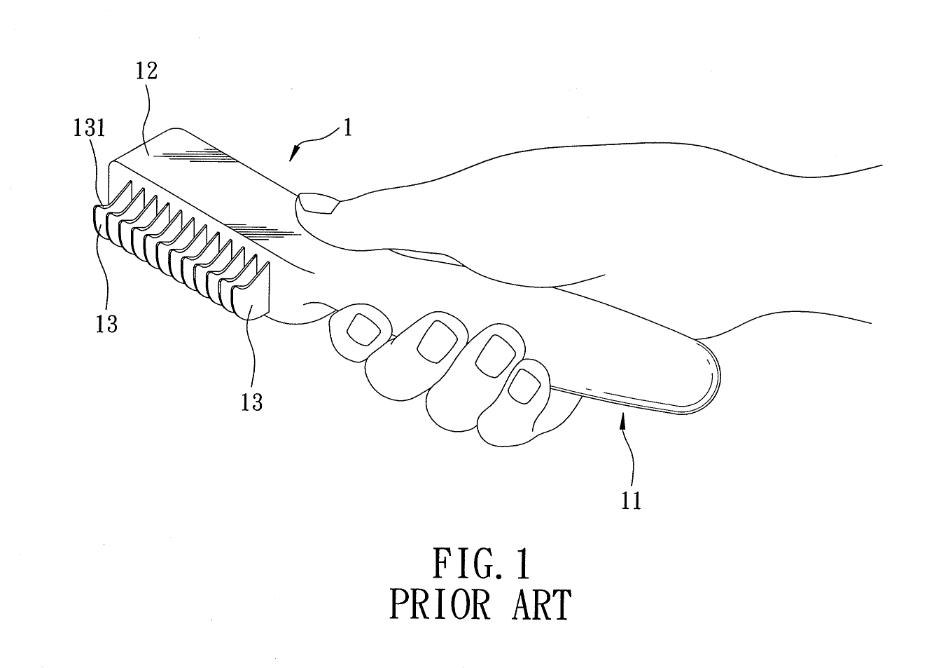

FIG. 2 is a perspective view showing the conventional pet hair razor used by a left-handed person;

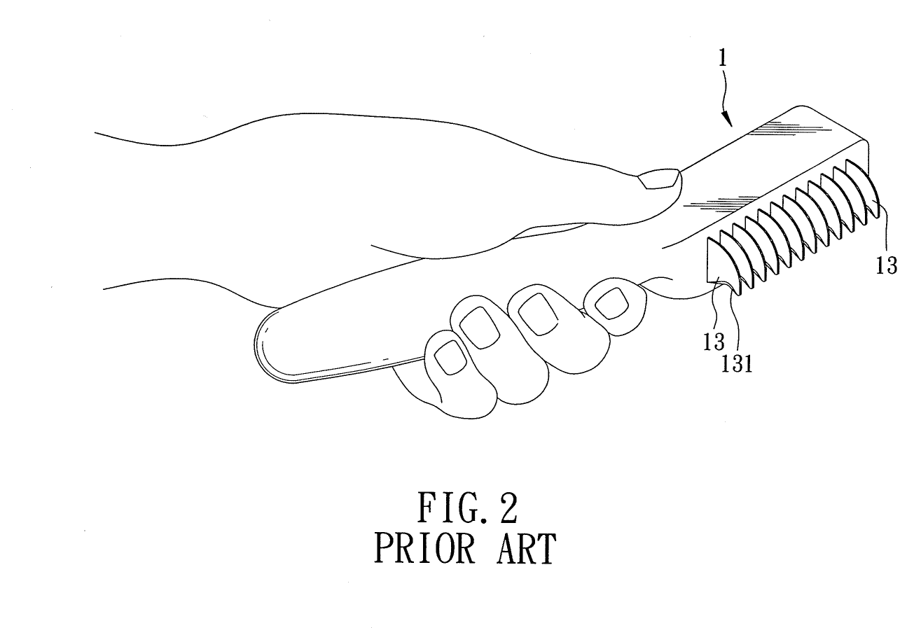

FIG. 3 is an exploded perspective view of the first preferred embodiment of a pet hair razor according to the present invention;

FIG. 4 is a perspective view showing the first preferred embodiment of the pet hair razor used by a right-handed person;

FIG. 5 is a perspective view showing the first preferred embodiment of the pet hair razor used by a left-handed person;

FIG. 6 is an exploded perspective view of the second preferred embodiment of a pet hair razor according to the present invention;

FIG. 7 is an exploded perspective view of the third preferred embodiment of a pet hair razor according to the present invention;

FIG. 8 is an exploded perspective view of the fourth preferred embodiment of a pet hair razor according to the present invention; and

FIG. 9 is an exploded perspective view of the fifth preferred embodiment of a pet hair razor according to the present invention.

### DETAILED DESCRIPTION OF THE PREFERRED EMBODIMENTS

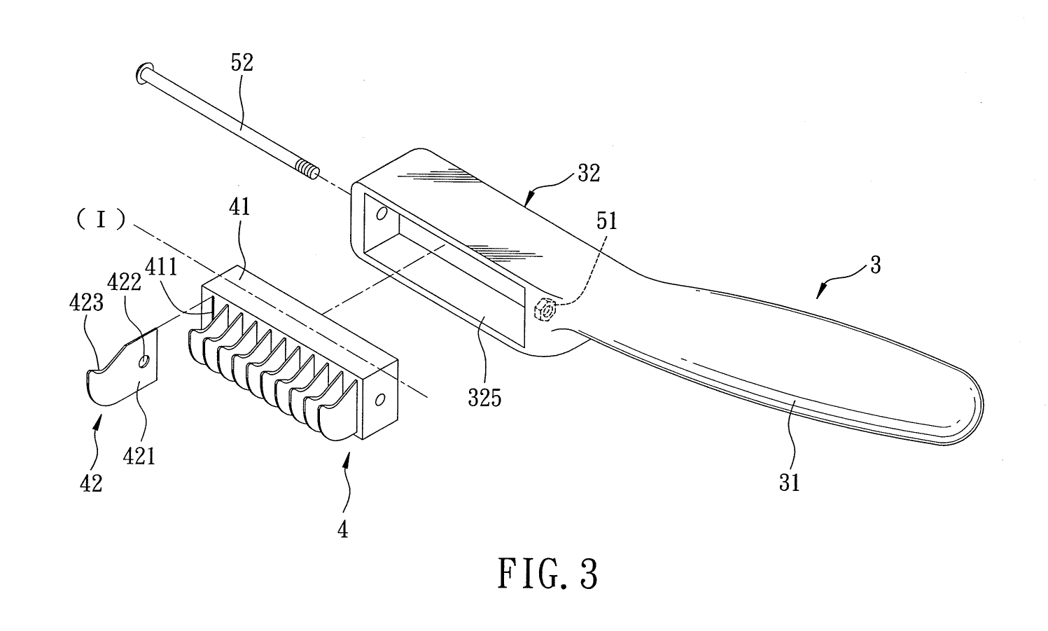

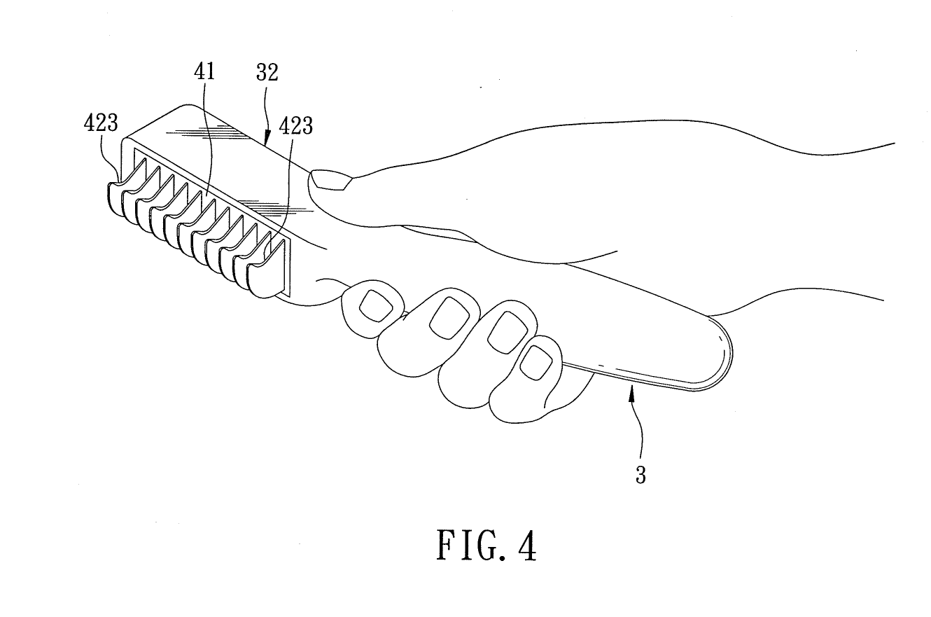

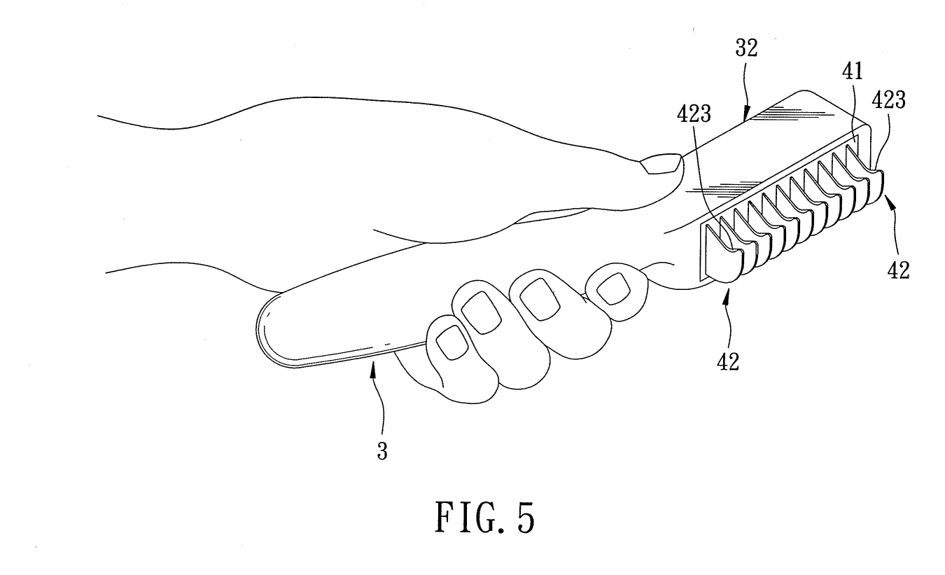

Referring to FIG. 3, the first preferred embodiment of a pet hair razor 100 according to the present invention is shown to include a handle part 3 and a comb part 4. The handle part 3 has an elongate grip portion 31 and a mounting seat 32 extending from the grip portion 31 along a length of the grip portion 31. A comb part 4 is provided with blades 42 that are aligned in a longitudinal direction (I) parallel to the length of the grip portion 31 in this embodiment. Each of the blades 42 has an edged side 423. The comb part 4 is mountable detachably on the mounting seat 32 between a first position, in which the edged sides 423 of the blades 42 face in a first direction and is suitable for a right-handed person (see FIG. 4), and a second position, in which the edged sides 423 of the blades 42 face in a second direction opposite to the first direction and is suitable for a left-handed person (see FIG. 5).

In this embodiment, as shown in FIG. 3, the mounting seat 32 is formed with a retaining recess 325. The comb part 4 has a blade-mounting body 41 rectangular in shape and snugly fitted into the retaining recess 325 when the comb part 4 is disposed at either one of the first and second positions.

In this embodiment, as shown in FIG. 3, the pet hair razor 100 further includes a screw nut 51 and a fastening bolt 52. The screw nut 51 is mounted on the mounting seat 32. The fastening bolt 52 extends in the longitudinal direction (I) through the blade-mounting body 41 to engage threadedly the screw nut 51.

Moreover, each of the blades 42 has a root portion 421 that is formed with a through-hole 422. The blade-mounting body 41 of the comb part 4 is formed with a plurality of slots 411 that are aligned in the longitudinal direction (I). The root portion 421 of each of the blades 42 is inserted into a respective one of the slots 411. The fastening bolt 52 extends through the through-hole 422 in the root portion 421 of each of the blades 42. With such design, some of the blades 42 which are blunt can be replaced without discarding the entire pet hair razor 100.

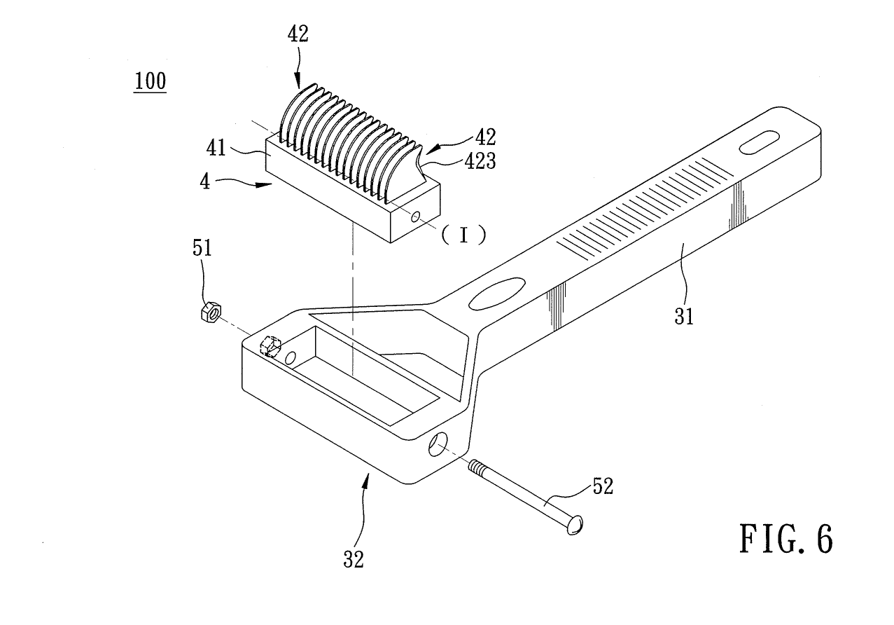

FIG. 6 illustrates the second preferred embodiment of the pet hair razor 100 according to this invention. This preferred embodiment differs from the first preferred embodiment in that the longitudinal direction (I) is transverse to the length of the grip portion 31.

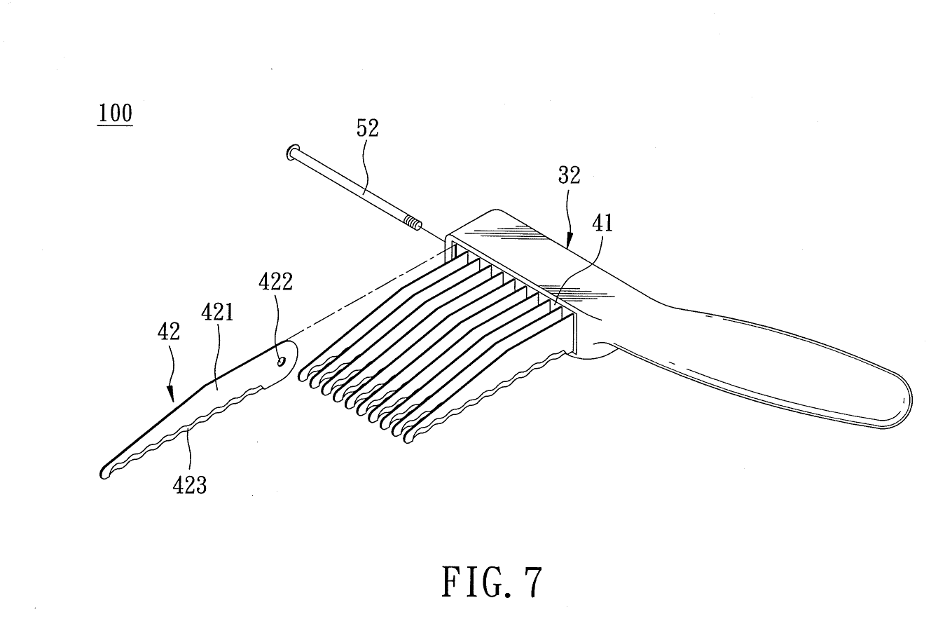

FIG. 7 illustrates the third preferred embodiment of the pet hair razor 100 according to this invention. This preferred embodiment differs from the first preferred embodiment in that each of the blades 42 has a wavy edged side 423 suitable for a pet with long hair.

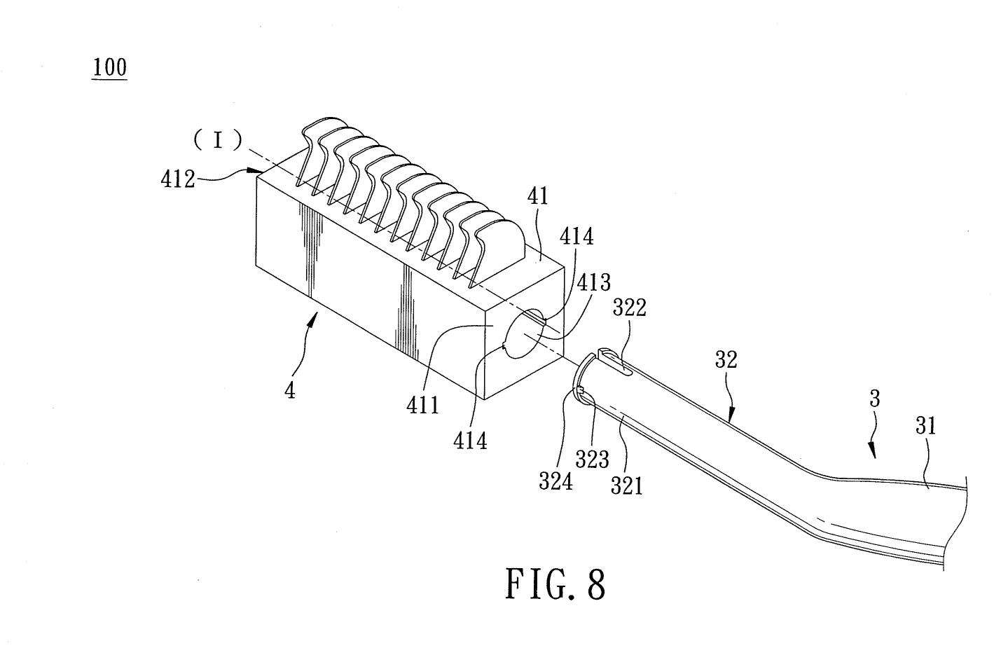

FIG. 8 illustrates the fourth preferred embodiment of the pet hair razor 100 according to this invention. This preferred embodiment differs from the first preferred embodiment in the engagement between the mounting seat 32 and the blade-mounting body 41.

As shown in FIG. 8, the mounting seat 32 is tubular in shape and extends in the longitudinal direction (I). The blade-mounting body 41 of the comb part 4 has two opposite end faces 411, 412 and is formed with a circular retaining hole 413 extending through the two end faces 411, 412. The mounting seat 32 is snugly fitted into the retaining hole 413. Specifically, the mounting seat 32 has an end portion 321 that is formed with a pair of diametrically disposed slits 322, a pair of diametrically disposed protrusions 323, and an annular end flange 324 protruding therefrom. The blade-mounting body 41 is further formed with a pair of diametrically disposed guiding grooves 414 that are in spatial communication with the retaining hole 413. When the mounting seat 32 is to be inserted into the retaining hole 413, the end portion 321 of the mounting seat 32 is pressed such that the diameter of the annular end flange 324 becomes smaller than that of the retaining hole 413. Then, the pressed end portion 321 of the mounting seat 32 is inserted into the retaining hole 413. At this time, the protrusions 323 are respectively received in the guiding grooves 414 so as to guide movement of the mounting seat 32 in the retaining hole 413 in the blade-mounting body 41. After passing through the retaining hole 413, the end flange 324 of the end portion 321 of the mounting seat 32 abuts against an adjacent one of the end faces 411, 412 of the blade-mounting body 41 when the comb part 4 is disposed at a respective one of the first and second positions.

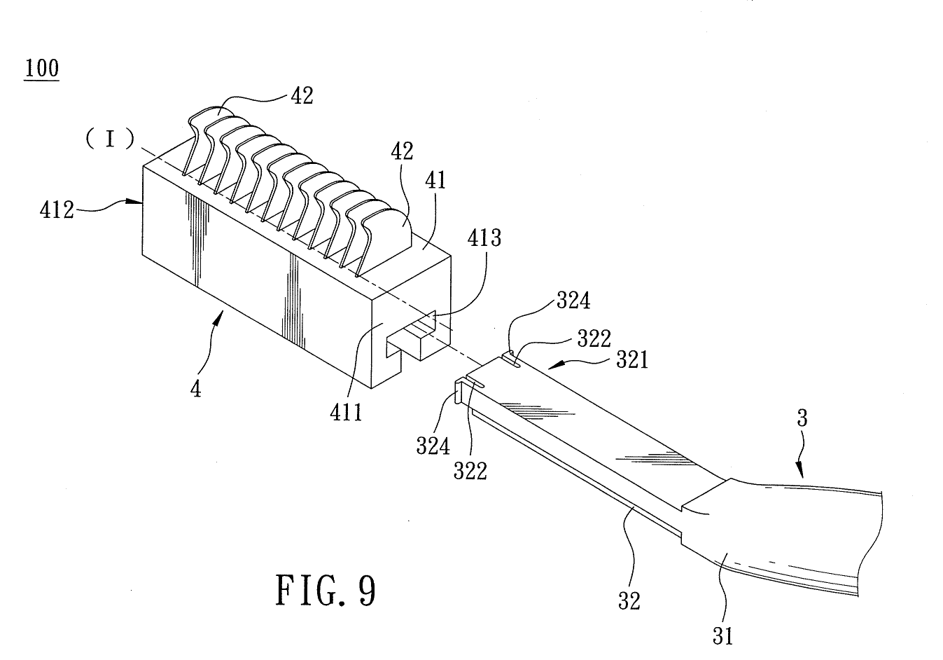

FIG. 9 illustrates the fifth preferred embodiment of the pet hair razor 100 according to this invention. This preferred embodiment differs from the first preferred embodiment in the engagement between the mounting seat 32 and the blade-mounting body 41.

As shown in FIG. 9, the mounting seat 32 extends in the longitudinal direction (I) and has a T-shaped cross-section. The mounting seat 32 has an end portion 321 that is formed with a pair of diametrically disposed slits 322 and two opposite end flanges 324 protruding therefrom. The blade-mounting body 41 of the comb part 4 has two opposite end faces 411, 412 and is formed with a retaining hole 413 extending through the two end faces 411, 412 and having a T-shaped cross-section corresponding to that of the mounting seat 32. When the mounting seat 32 is to be inserted into the retaining hole 413, the end portion 321 of the mounting seat 32 is pressed so as to permit insertion of the end portion 321 of the mounting seat 32. After passing through the retaining hole 413, the end flanges 324 of the end portion 321 of the mounting seat 32 abut against an adjacent one of the end faces 411, 412 of the blade-mounting body 41 when the comb part 4 is disposed at a respective one of the first and second positions.

According to the present invention, since the direction of the edged sides 423 of the blades 42 can be changed by changing the position of the blade-mounting body 41 relative to the mounting seat 32, the pet hair razor 100 of this invention can be used by a right-handed person and a left-handed person. In addition, each of the blades 42 can be individually replaced, thereby resulting in lower costs compared to the prior art, which requires replacement of the whole razor when some of the blades become blunt.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A pet hair razor, comprising:
a handle part having a mounting seat; and
a comb part provided with blades that are aligned in a longitudinal direction, each of said blades having an edged side, said comb part being mountable detachably on said mounting seat between a first position, in which said edged sides of said blades face in a first direction, and a second position, in which said edged sides of said blades face in a second direction opposite to said first direction.

2. The pet hair razor of claim 1, wherein said mounting seat is formed with a retaining recess, said comb part having a blade-mounting body snugly fitted into said retaining recess when said comb part is disposed at either one of the first and second positions.

3. The pet hair razor of claim 2, further comprising a fastening bolt and a screw nut, said screw nut being mounted on said mounting seat, said fastening bolt extending in the longitudinal direction through said blade-mounting body to engage threadedly said screw nut.

4. The pet hair razor of claim 3, wherein each of said blades has a root portion that is formed with a through-hole, said blade-mounting body of said comb part being formed with a plurality of slots that are aligned in the longitudinal direction, said root portion of each of said blades being inserted into a respective one of said slots, said fastening bolt extending through said through-hole in said root portion of each of said blades.

5. The pet hair razor of claim 4, wherein said blade-mounting body is rectangular in shape.

6. The pet hair razor of claim 1, wherein said mounting seat is tubular in shape, said comb part having a blade-mounting body that is formed with a retaining hole, said mounting seat being snugly fitted into said retaining hole.

7. The pet hair razor of claim 6, wherein said mounting seat has an end portion that is formed with a pair of diametrically disposed slits and a pair of diametrically disposed protrusions, said blade-mounting body being further formed with a pair of diametrically disposed guiding grooves that are in spatial communication with said retaining hole, said protrusions being respectively received in said guiding grooves so as to guide movement of said mounting seat in said retaining hole.

8. The pet hair razor of claim 7, wherein said end portion of said mounting seat is formed with an annular end flange protruding therefrom, said blade-mounting body having two opposite end faces, said retaining hole extending through said end faces, said end flange of said end portion of said mounting seat abutting against an adjacent one of said end faces of said blade-mounting body when said comb part is disposed at a respective one of the first and second positions.

9. The pet hair razor of claim 1, wherein said mounting seat has a T-shaped cross-section, said comb part having a blade-mounting body formed with a retaining hole that has a T-shaped cross-section, said mounting seat being snugly fitted into said retaining hole.

10. The pet hair razor of claim 9, wherein said mounting seat has an end portion that is formed with a pair of diametrically disposed slits and two opposite end flanges protruding therefrom, said blade-mounting body having two opposite end faces, said retaining hole extending through said end faces, said end flanges of said end portion of said mounting seat abutting against an adjacent one of said end faces of said blade-mounting body when said comb part is disposed at a respective one of the first and second positions.
